(19) United States
(12) Patent Application Publication
(10) Pub. No.: US 2021/0155346 A1
(43) Pub. Date: May 27, 2021

(54) GRASPING APPARATUS AND A VEHICLE INCLUDING A GRASPING APPARATUS

(71) Applicant: AUCKLAND UNISERVICES LIMITED, AUCKLAND (NZ)

(72) Inventor: Minas Liarokapis, Auckland (NZ)

(21) Appl. No.: 16/954,163

(22) PCT Filed: Dec. 14, 2018
(86) PCT No.: PCT/IB2018/060074

§ 371 Date: Jun. 15, 2020

(30) Foreign Application Priority Data
Dec. 15, 2017 (NZ) 738432

(51) Int. Cl. B64D 1/10; B64C 39/02; B64D 1/22; B64C 1/22

(52) U.S. Cl. CPC B64D 1/10; B64C 39/024; B64C 2201/128; B64C 1/22; B64D 1/22

(57) ABSTRACT

An unmanned aerial vehicle comprising a frame, one or more propulsion units disposed on the frame and a grasping apparatus for grasping a payload. The grasping apparatus is reconfigurable between a first configuration and a second configuration and/or any position between the first and second configuration. In the second configuration the grasping apparatus corresponds to a grasping configuration to grasp the payload and the first configuration corresponds to an ungrasping configuration not grasping the pay load.

### FIELD OF THE INVENTION

The present invention relates to vehicles including aerial, ground or seafaring vehicles. In particular, but not limited to, the present invention relates to unmanned aerial vehicles comprising grasping capabilities or a grasping apparatus to grasp and transpose objects. The present invention also relates to a grasping apparatus for grasping an object, wherein the grasping apparatus is associated with or useable with a vehicle.

### BACKGROUND

Typically, aerial grasping platforms use drones that have either a robot hand or a robot grasping attached. The majority of robot hands or robotic grasping structures can be quite heavy (for example some can weigh more than 500 g). Most drones have a limited payload i.e. have a weight constraint associated with the drone. Moreover, as the payload and weight of the drone increases the maximum flight time and the autonomy of the drone decreases thereby limiting the usability of the drone. Therefore, those drones capable of picking up objects have limited use and may only be used for shorter transportation distances.

Another important specification for aerial grasping platforms is to be capable to grasp objects, even under significant object position uncertainties (when the object position is not certain or a-priori known). This is particularly useful for drones, as they cannot be controlled accurately and the presence of external disturbances (e.g., wind) makes the problems of approaching the object and securing a grasp, extremely difficult.

For drones that include a robotic hand, the most important factor that affects the weight of the devices is the number of motors used. Thus, most lightweight devices use the concept of under-actuation (less motors that the available degrees of freedom). Those drones that rely on a robot hand for grasping have a limited workspace, increased weight, increased power consumption, decreased payload and decreased flight time.

### SUMMARY OF THE INVENTION

It is an object of the invention to provide a vehicle, for example an unmanned aerial vehicle comprising a reconfigurable grasping apparatus to grasp and transpose objects, or at least provide the public with a useful choice.

In one aspect the invention broadly consists in an unmanned aerial vehicle comprising:
a frame,
one or more propulsion units disposed on the frame,
a grasping apparatus for grasping a payload associated with the frame, wherein the grasping apparatus is configured to grasp or release a payload, wherein the grasping apparatus is reconfigurable between a first configuration and a second configuration and/or any position between the first and second configuration, wherein the second configuration corresponds to a grasping configuration to grasp the payload and the first configuration corresponds to an ungrasping configuration not grasping the pay load.

Preferably the grouping apparatus is configured to be peripheral to the pay load and a perimeter of the grasping apparatus is varied or is variable as the grasping apparatus is reconfigured between a first configuration and a second configuration.

Preferably the grasping apparatus is integral to the frame such that the grasping apparatus forms at least part of the entire frame. Preferably the grasping apparatus defines the frame i.e. the grasping apparatus forms the frame such that the frame functions to grasp an object e.g. a payload.

Preferably the grasping apparatus forms part of the frame. Preferably the grasping apparatus is the frame and at least a portion of the frame is configured to change shape as the grasping apparatus is reconfigured between a first configuration and a second configuration.

Preferably the grasping apparatus comprises one or more reconfigurable members that are configured to alter in shape to reconfigure the grasping apparatus between a first configuration and a second configuration.

Preferably the one or more reconfigurable members comprise a resilient structure.

Preferably in one configuration the grasping apparatus comprises a continuous reconfigurable member that defines the grasping apparatus.

Preferably the continuous reconfigurable member is able to assume an enclosed arcuate or circular or oval shape.

Preferably the grasping apparatus comprises one or more rigid members and wherein the one or more reconfigurable members are coupled to the one or more rigid members.

Preferably in another configuration the grasping apparatus comprises a polygon shape, the polygon shape being defined by a plurality of the rigid members and a plurality of the reconfigurable members.

Preferably each reconfigurable member is interconnected between two rigid members, the reconfigurable member separating the two rigid members from each other and altering the distance between them.

Preferably the grasping apparatus comprises an equal number of reconfigurable members and rigid members.

Preferably the grasping apparatus is substantially square or rectangular shaped.

Preferably the grasping apparatus comprises a linking member, the linking member being coupled to at least the one or more reconfigurable members such that actuation of the linking member causing the one or more reconfigurable members to reconfigure in shape thereby causing the grasping apparatus or the frame to reconfigure between the first configuration and second configuration and/or any position between the first configuration and second configuration.

Preferably the linking member is coupled to an actuator, the actuator causing actuation of the linking member thereby causing the one or more reconfigurable members to reconfigure in shape.

Preferably the linking member passes through each of the one or more reconfigurable members.

Preferably the unmanned aerial vehicle comprises an actuator, the linking member being coupled to the actuator and the actuator configured to vary the length of the linking member in order to cause reconfiguration of the one or more reconfigurable members based on the length of the linking member.

Preferably the actuator is configured to vary the length of the linking member by applying a tensile force to the linking member.

Preferably the actuator is configured to reduce the length of the linking member in order to reduce the perimeter of the grasping apparatus such that the grasping apparatus is reconfigured into the second configuration for grasping a payload.

Preferably the reconfigurable member may comprise a plurality of rigid elements connected between compliant (i.e. resilient) elements to form the reconfigurable member. Preferably the rigid elements may be linkages that link two compliant elements together. Preferably the rigid elements provide structural support and also act to limit the deformation (i.e. reconfiguration) of the reconfigurable members along one or more planes. Preferably the type deformation planes can be defined by the structure of the reconfigurable member, in particular the arrangement of rigid elements and compliant elements. Preferably in one exemplary configuration the reconfigurable member comprises alternating rigid and compliant elements and reconfiguration (i.e. deformation) of the reconfigurable member is limited to a single plane.

Preferably in an alternate configuration the reconfigurable member may comprise a rigid spline that provides rigidity and structural support to the compliant elements of the reconfigurable member. The rigid spline can also help to limit reconfiguration to a single plane.

Preferably in a further configuration the reconfigurable member comprising a telescoping assembly, to allow a portion of the reconfigurable member to extend and/or contract in order to cause the reconfigurable member to reconfigure between a first configuration and a second configuration.

Preferably the unmanned aerial vehicle comprises an actuator, wherein the actuator is coupled to the reconfigurable member and the actuator further configured to actuate the telescoping assembly in order to cause the reconfigurable member to reconfigure between a first configuration and a second configuration.

Preferably the actuator is configured to actuate the telescoping member to cause a reduction or an increase in the perimeter of the grasping apparatus in order to grasp or release a payload.

Preferably the grasping apparatus is under-actuated such that the number of actuators for reconfiguring the shape of the grasping apparatus is less than the number of degrees of movement of the grasping apparatus as the grasping apparatus is reconfigured between a first configuration and a second configuration.

Preferably the unmanned aerial vehicle comprising at least two propulsion units. Preferably the unmanned aerial vehicle comprises three or more propulsion units. The number of propulsion units used is dependent on the size of the unmanned aerial vehicle and its payload limit i.e. based mainly on the weight and thrust required to fly the unmanned aerial vehicle. Preferably in an alternate configuration the unmanned aerial vehicle may comprise a single propulsion unit.

Preferably the propulsion units are evenly disposed relative each other on the frame. Preferably the frame supports the propulsion units and the propulsion units may be coupled to the frame. Preferably the frame may comprise additional mounting structures e.g. one or more plates or slabs or platforms upon which the propulsion units are mounted and supported. Preferably the frame may also include thickened regions of the frame to provide support for the propulsion units.

Preferably the propulsion units move with the part of the frame at where they are attached to the frame so that as the frame reconfigures the relative position of the propulsion units to each other changes.

Preferably the one or more propulsion units are propellers. Preferably the propellers preferably comprise a rotor with two or more blades that can rotate to generate lift and provide thrust.

Preferably the propulsion units may be mounted on pivotable mounts that may be controlled by a further actuator to allow pivoting of the propulsion units in various directions to provide thrust in various directions.

Preferably the grasping apparatus comprises a compliant pad disposed on an inner side or on a payload proximal side of the grasping apparatus.

Preferably the compliant pad is disposed on the rigid members of the grasping apparatus and the compliant pad extends at least a partial length of the rigid member.

Preferably the perimeter of the frame is altered as the one or more members is moved in order to grasp or release a payload.

Preferably the perimeter of the frame is reduced in, as compared to an at rest perimeter of the frame in order to grasp a payload.

In another aspect, the present invention broadly consists of an unmanned aerial vehicle for carrying a payload comprising:
a frame
a plurality of propulsion devices disposed on the frame,
the frame comprising one or more members defining a grasping apparatus, the one or more members being moveable to alter the perimeter of the frame to thereby grasp and release the payload.

In another aspect, the present invention broadly consists of an unmanned aerial vehicle (UAV) comprising:
a chassis,
a plurality of propulsion units disposed on the chassis and configured to provide propulsion to the UAV,
a grasping apparatus associated with the chassis, the grasping apparatus comprises one or more deformable members, the one or more deformable members defining the grasping apparatus and wherein the one or more deformable members configured to deform between a rest configuration and a deformed configuration in order to grasp a payload.

In another aspect, the present invention broadly consists of an unmanned aerial vehicle (UAV) comprising:
a frame,
a plurality of propulsion units disposed on the frame and configured to provide propulsion to the unmanned aerial vehicle,
the frame comprising a plurality of deformable members and a plurality of rigid members, at least one deformable member being interconnected to at least one rigid member,
an actuator operatively coupled to the plurality of deformable members, the actuator configured to alter the shape of the plurality of deformable members such that the shape or perimeter of the frame is altered in order to grasp a payload.

In another aspect, the present invention broadly consists of a grasping apparatus for grasping an object comprising:
a body,
the body comprising one or more reconfigurable members that are configured to alter in shape as the grasping apparatus is reconfigured between a first configuration and a second configuration, wherein the second configuration corresponds to a grasping configuration in which the grasping apparatus grasps the object and the first configuration corresponds to a release (i.e. ungrasping) configuration.

Preferably the one or more reconfigurable members are comprise a resilient structure.

Preferably in one configuration the grasping apparatus comprises a continuous reconfigurable member that defines the grasping apparatus.

Preferably the continuous reconfigurable member defines an enclosed arcuate or circular or oval shape.

Preferably in another configuration the grasping apparatus comprises one or more rigid members and wherein the one or more reconfigurable members are coupled to the one or more rigid members.

Preferably the grasping apparatus comprises a polygon shape, the polygon shape being defined by a plurality of the rigid members and a plurality of the reconfigurable members.

Preferably the grasping apparatus comprises an equal number of reconfigurable members and rigid members.

Preferably the grasping apparatus is substantially square or rectangular shaped.

Preferably the grasping apparatus comprises a linking member, the linking member being coupled to at least the one or more reconfigurable members such that actuation of the linking member causing the one or more reconfigurable members to reconfigure in shape thereby causing the grasping apparatus or the frame to reconfigure between the first configuration and second configuration and/or any position between the first configuration and second configuration.

Preferably the linking member is coupled to an actuator, the actuator causing actuation of the linking member thereby causing the one or more reconfigurable members to reconfigure in shape.

Preferably the linking member passes through each of the one or more reconfigurable members.

Preferably the grasping apparatus as per one or more earlier statements comprises an actuator, the linking member being coupled to the actuator and the actuator configured to vary the length of the linking member in order to cause reconfiguration of the one or more reconfigurable members based on the length of the linking member.

Preferably the actuator is configured to vary the length of the linking member by applying a tensile force to the linking member.

Preferably the actuator is configured to reduce the length of the linking member in order to reduce the perimeter of the grasping apparatus such that the grasping apparatus is reconfigured into the second configuration for grasping an object.

Preferably in another configuration the reconfigurable member (members) comprising a telescoping assembly, to allow a portion of the reconfigurable member to extend and/or contract in order to cause the reconfigurable member to reconfigure between a first configuration and a second configuration.

Preferably the grasping apparatus comprises an actuator, wherein the actuator is coupled to the reconfigurable member and the actuator further configured to actuate the telescoping assembly in order to cause the reconfigurable member to reconfigure between a first configuration and a second configuration.

Preferably the actuator is configured to actuate the telescoping member to cause a reduction or an increase in the perimeter of the grasping apparatus in order to grasp or release an object.

Preferably the grasping apparatus is under-actuated such that the number of actuators for reconfiguring the shape of the grasping apparatus is less than the number of degrees of movement of the grasping apparatus as the grasping apparatus is reconfigured between a first configuration and a second configuration.

Preferably the grasping apparatus according comprises a coupler for removably or permanently coupling the grasping apparatus to an aerial vehicle or a ground vehicle or an unmanned aerial vehicle.

Preferably the term unmanned aerial vehicle means a vehicle capable of flight or propulsion that is capable of being piloted via remote control or by one or more onboard controllers. Preferably the term unmanned aerial vehicle can be interchanged with the term drone. Preferably the term vehicle as used herein means a thing or object used to transport goods and/or people via land, air or sea. Preferably the term vehicle can cover both unmanned and manned vehicles as well as autonomous or partially autonomous guided vehicles. Preferably the present invention may be applied to an unmanned or manned aerial vehicle. Preferably the present invention may also be applied to ground or sea fearing vehicles. Preferably the present invention is described with reference to an unmanned aerial vehicle can be particularly useful with an unmanned aerial vehicle. It should be understood the invention described herein may be applied to many vehicles to provide improved grasping and transporting capabilities.

In another aspect, the present invention broadly consists of a grasping apparatus for grasping about an object the grasping apparatus comprising:
a body to peripherally locate about the object and being reconfigurable between a condition not grasping the object and a condition where the body is at least in part compliant to the periphery of the object sufficient to grasp the object.

Preferably the frame is of a fixed configuration and the grasping apparatus comprises of a plurality of reconfigurable members supported by the frame.

Preferably the plurality of reconfigurable members are arms pivotally engaged to the frame to each be able to rotate relative the frame so that distal ends of the arms can displace in a converging and diverging manner relative each other.

Preferably the distal ends of the arms are at where the pay load is grasped.

Preferably the distal ends of the arms are presented in their grasping condition inwards of the frame.

Preferably the arms are biased towards a rotational position at where the arms are in a grasping condition.

Preferably each arm is biased by a spring or elastic of compressible member acting between the arm and the frame.

Preferably the arms are collectively coupled to a flexible elongate member able to contract and expand in effective length and routed with each arm in a manner to cause the arms to collectively pivot about their respective pivot axes as the elongate member contracts and/or expands in effective length.

The term grasping apparatus means any structure or set of elements or arrangement for grasping an object e.g. a payload. The term payload is an example object that can be grasped. The term payload and object may be interchangeably used herein to define a thing that is held or grasped by a grasping apparatus.

It will be appreciated that the grasping configuration is not always the same and is dependent on the shape and positioning of the payload relative to the grasping apparatus.

The term payload and object are interchangeably used to define a thing that is grasped by a grasping apparatus according to the present disclosure.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both. The invention consists in the foregoing and also envisages constructions of which the following gives examples only.

Further aspects of the invention, which should be considered in all its novel aspects, will become apparent from the following description.

### DRAWING DESCRIPTION

Some embodiments of the invention will now be described by way of example with reference to the drawings as follows.

FIG. 1 shows a first embodiment of an unmanned aerial vehicle comprising a grasping apparatus in an open configuration.

FIG. 2 shows a first embodiment of the unmanned aerial vehicle of FIG. 1 in a closed configuration (grasping configuration).

FIG. 3 shows a second embodiment of the unmanned aerial vehicle comprising a grasping apparatus in an open configuration.

FIG. 4 shows a second embodiment of the unmanned aerial vehicle of FIG. 3 in a closed configuration for grasping.

FIG. 5 shows a third embodiment of the unmanned aerial vehicle comprising a grasping apparatus in an open configuration.

FIG. 6 shows a third embodiment of the unmanned aerial vehicle of FIG. 5 in a closed configuration for grasping.

FIG. 7 shows a fourth embodiment of the unmanned aerial vehicle comprising a grasping apparatus in an open configuration.

FIG. 8 shows a fourth embodiment of the unmanned aerial vehicle of FIG. 7 in a closed configuration for grasping.

FIG. 9 shows a close up of a fourth embodiment of the unmanned aerial vehicle.

### DETAILED DESCRIPTION OF THE DRAWINGS

The present disclosure relates to unmanned aerial vehicles or drones. In particular, but not limited to, the present invention relates to unmanned aerial vehicles or drones comprising grasping capabilities or a grasping apparatus to grasp objects. The unmanned aerial vehicle (UAV) may be a reconfigurable UAV or drone that can be reconfigured in shape (i.e. re-shaped) so as to grasp a number of different shaped payloads (i.e. items), such as for example packages. A portion of the UAV is configured to alter in shape in order to grasp or release a payload. The UAV may also be configured to transport the payload.

The present disclosure relates to an unmanned aerial vehicle (UAV) for comprising; a frame (i.e. chassis), one or more propulsion units disposed on the frame, a grasping apparatus for grasping a payload that is formed integral with the frame, wherein the grasping apparatus is configured to grasp or release a payload, wherein the grasping apparatus is reconfigurable between a first configuration and a second configuration and/or many position between the first and second configuration, wherein the second configuration corresponds to a grasping configuration to grasp the payload and the first configuration corresponds to an ungrasping configuration. The grasping apparatus may change shape as it reconfigures between a first configuration and a second configuration. For example the external shape i.e. perimeter of the grasping apparatus may be altered as the grasping apparatus is reconfigured between a first configuration and a second configuration. The unmanned aerial vehicle (UAV) may be configured to transport a payload that is grasped. In this embodiment the grasping apparatus may be formed as part of the frame and may define the frame (i.e. chassis). Alternatively the grasping apparatus may be integrally coupled or attached to the frame. The grasping apparatus may be configured to substantially conform to the shape (e.g. the outer shape) of the payload when the grasping apparatus is in the grasping configuration.

The present disclosure also relates to an unmanned aerial vehicle for carrying a payload comprising; a frame (i.e. chassis), a plurality of propulsion devices disposed on the frame, the frame comprising one or more members defining a grasping apparatus, the one or more members being moveable to grasp or release a payload wherein the movement of the one or more members alters the perimeter of the frame. The unmanned aerial vehicle may be configured to grasp and transport a payload from one location to another. In one example the perimeter of the frame may be reduced in order to grasp the payload or many other object. Alternatively the frame may be configured such that the perimeter of the frame increases in order to grasp the payload or other object.

The present disclosure relates to an unmanned aerial vehicle for carrying a payload comprising; a frame, a plurality of propulsion devices disposed on the frame, the frame comprising one or more members defining a grasping apparatus, the one or more members being moveable to grasp or release a payload or object wherein the movement of the one or more members alters the perimeter of the frame. For example, the perimeter may increase or decrease as the one or more members are moved i.e. as the frame is reconfigured in shape.

The present disclosure relates to an unmanned aerial vehicle (UAV) comprising; a chassis, a plurality of propulsion units disposed on the chassis and configured to provide propulsion to the UAV, a grasping apparatus associated with the chassis, the grasping apparatus comprises one or more deformable members, the one or more deformable members defining the grasping apparatus and wherein the one or more deformable members configured to deform between a rest position and a deformed position in order to grasp a payload or other object. The grasping apparatus may substantially conform to the shape of the payload when in a deformed position. The deformed position corresponds to a grasping configuration.

The present disclosure may relate to a grasping apparatus for grasping an object comprising; a body, the body comprising one or more reconfigurable members that are configured to alter in shape as the grasping apparatus is reconfigured between a first configuration and a second configuration, wherein the second configuration corresponds to a grasping configuration in which the grasping apparatus grasps the object and the first configuration corresponds to a release configuration (i.e. an ungrasping configuration) to release the object. The object may be a payload or many other objects that is required to be grasped. The grasping apparatus may be configured to alter in shape to substantially conform to the geometry (i.e. shape) of the object in order to grasp the object. The grasping apparatus is configured to create at least two points of contact with the object in order to grasp the object. The grasping apparatus may comprise a coupler for removably or permanently coupling the grasping apparatus to an unmanned aerial vehicle or a vehicle. Alternatively the grasping apparatus may be integral with an unmanned aerial vehicle or drone or other vehicle. In one example the grasping apparatus may define a frame or chassis of an unmanned aerial vehicle, such that the frame or chassis functions as a grasping apparatus.

The unmanned aerial vehicle i.e. drone as described herein utilizes an adaptive grasping paradigm to grasp a payload (i.e. an object). The adaptive grasping paradigm involves the use of a reconfigurable grasping apparatus that alters shape in order to grasp a payload. In one configuration the reconfigurable grasping apparatus is incorporated as part of the body of the vehicle such that the body i.e. frame functions as the grasping apparatus. The frame (or body) changes shape to grasp objects e.g. a payload. The unmanned aerial vehicle, in particular the grasping apparatus is configured to operate using the principle of under-actuation. The grasping apparatus as disclosed herein is under-actuated such that the number of actuators for reconfiguring the shape of the grasping apparatus is less than the number of degrees of freedom (e.g., motion) of the grasping apparatus. The under-actuation operating parameter is advantageous because the number of actuators required is reduced, thereby reducing the overall weight of the unmanned aerial vehicle that incorporates the under actuated grasping apparatus. The under actuated grasping apparatus also provides simpler and cheaper construction.

The structure of the grasping apparatus described herein also utilises structural compliance/resilience (e.g., uses a resilient/elastic components in the structure, like torsion and compression springs or other elastic elements (e.g., urethane or silicone rubber sheets) in order to offer robustness in grasping tasks even under object position or environmental uncertainties (e.g., in the presence of external disturbances as wind). Additionally, the grasping apparatus as described herein, or used with an unmanned aerial vehicle is flexible and comprises some resilience, such that the grasping apparatus will not crush or damage the object during grasping and transporting. The grasping apparatus is advantageous because it can be used to grasp a number of different shaped payloads such as for example everyday life objects as well as fragile objects without damaging the objects.

The unmanned aerial vehicle (i.e. drone) is capable of grasping a variety of everyday life objects. The unmanned aerial vehicle comprises a grasping apparatus that is reconfigurable. The grasping apparatus forms the frame i.e. defines the frame of the drone. The grasping apparatus (and frame) is configured to change shape as the grasping apparatus moves from a first configuration to a second configuration, wherein the first configuration corresponds to an ungrasping configuration and the second configuration corresponds to a grasping configuration. The grasping apparatus (and frame) of the drone includes one or more compliant members (i.e. reconfigurable members) that can change shape. The reconfigurable members facilitate a planar reconfiguration of the grasping apparatus (and frame), constraining the out of plane motions that may destabilize flying.

Grasping is achieved via the grasping apparatus (and frame) reconfiguration that shrinks the available space between the members of the grasping apparatus. The reconfiguration can be executed using a single actuator, minimizing the weight and the development cost of the drone. Such drones i.e. UAVs are particularly useful for package delivery (e.g., Amazon drone delivery, first aid emergency response and search and rescue operations, but could be used for other transportation of objects, such as food or beverage deliveries and the like).

A first embodiment of an unmanned aerial vehicle 100 is shown in FIG. 1. The unmanned aerial vehicle (i.e. drone) 100 comprises a frame 102, a plurality of propulsion units 110, 111, 112, 113 (110-113) and a grasping apparatus 120. The propulsion units 110-113 are mounted on the frame 102. The unmanned aerial vehicle 100 comprises at least three propulsion units. In some configurations at least two propulsion units may be used.

In the illustrated embodiment of FIG. 1, the drone 100 comprises four propulsion units 110-113. The four propulsion units 110-113 are spaced apart from each other. Preferably the propulsion units 110-113 are equally spaced from each other around the frame 102. Spacing may change as the frame reconfigures. The UAV 100 may comprise other structures or structural features that may be used to support the propulsion units.

The propulsion units 110-113 are preferably equally spaced from each other to balance the UAV during flight such that the UAV (i.e. drone) is stable once it has grasped the payload and such that the UAV is stable in flight. In the illustrated example the propulsion units 110-113 are propellers that comprise a plurality of propeller blades. The propellers may include two or more propeller blades. Alternatively the propulsion units can be many other suitable propulsion units. Many number of propulsion units may be used as is appropriate for the size and payload required of the particular drone.

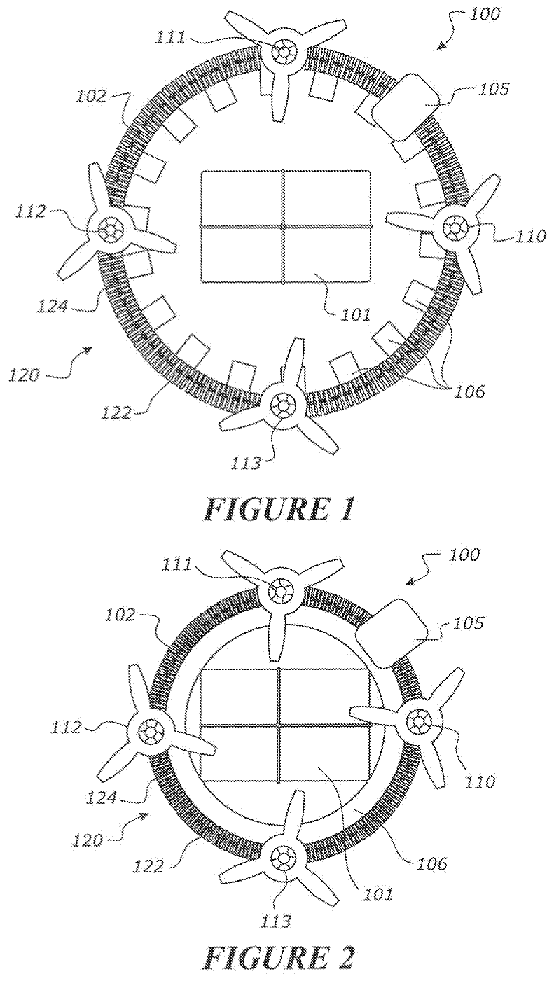

As shown in FIG. 1 the grasping apparatus 120 is integral to the frame 102. The grasping apparatus 120 defines at least a portion of the frame 102. As illustrated in FIGS. 1 and 2, the frame 102 defines the grasping apparatus 120. The frame 102 functions as a grasping apparatus to grasp an object e.g. a payload. As shown in FIGS. 1 and 2, the frame 102 can alter its shape i.e. the frame 102 is reconfigurable between a grasping configuration (as shown in FIG. 2) and a release or ungrasping configuration (as shown in FIG. 1). FIG. 1 shows the frame 102 (and grasping apparatus 120) in a first configuration that corresponds to a release or ungrasping configuration. FIG. 2 shows the frame 102 (and the grasping apparatus 120) in a second configuration that corresponds to a grasping/gripping position to grasp the payload 101.

In the first configuration (i.e. ungrasping configuration) the frame 102 is in an open configuration and is configured to be positioned about an object 101 (i.e. parcel 101). The frame 102 surrounds the object 101 when in an open position. The UAV 100 may be landed in a way such that the frame 102 surrounds the object 101. The frame 102 (and the grasping apparatus 120) are reconfigured such that the shape of the frame 102 (and the grasping apparatus 120) changes in shape such that the frame 102 contacts the object 101 in order to grasp the object 101. The grasping configuration is shown in FIG. 2. The frame 102 contacts the object 101 in at least two places, but preferably the frame 102 is reconfigured such that it maximises contact between the frame 102 and the object 101. The frame 102 may substantially conform to the shape of the object 101. The perimeter of the frame 102 reduces as the frame 102 reconfigures in shape to grasp the object 101.

The frame 102 may comprise one or more reconfigurable members. The drone 100, illustrated in FIGS. 1 and 2 comprises a single continuous reconfigurable member 122. The reconfigurable member 122 is configured to alter in shape as the frame 102 (and grasping apparatus 120) is reconfigured between a first configuration and a second configuration. The reconfigurable member 122 comprises a compressible structure. The reconfigurable member 122 comprises a resilient structure such as for example an elastomer spring-like structure, a spring loaded linear joint etc. In this embodiment that reconfigurable member 122 (and the frame) defines an enclosed arcuate or circular or oval shape. In the illustrated embodiment of FIGS. 1 and 2, the reconfigurable member 122 defines a substantially circular shape. The frame 102 defines a substantially circular shape.

The frame 122 comprises one or more rigid elements in combination with the resilient i.e. compressible structure. The frame 122, as shown in FIGS. 1 and 2, comprises a rigid, robust, durable and lightweight material such as for example carbon fibre or a hard plastic or other suitable lightweight, robust and durable material. In the configuration of FIGS. 1 and 2, the frame 122 comprises a combination of rigid elements and resilient members. The rigid elements may be the linkages. The resilient members may be formed from an elastomer (e.g. urethane or silicone rubber). The rigid elements preferably act as the linkages between consecutive resilient members. The structure of the alternating rigid and resilient members restricts deformation i.e. reconfiguration of the frame 1222 along a single plane.

Alternatively the reconfigurable member 122 may comprise a rigidizing element e.g. a rigid central rod or a spline or a rib that assists in maintaining structural integrity of the frame 102.

In one example the reconfigurable member 122 is a continuous ring of a spring that can be expanded or compressed. The expansion and compression of the reconfigurable member 122 (and frame 102) is not affected by the movement of the rotors 110-113.

The grasping apparatus 120 comprises a linking member 124. The linking member 124 is coupled to the reconfigurable member 122. The linking member 124 extends along the length of the frame 102. The linking member 124 preferably extends through the reconfigurable member 122. The reconfigurable member 122 may include a hollow passage and the linking member 124 extending through the hollow passage. Actuation of the linking member 124 causes the reconfigurable member 122 to reconfigure in shape thereby causing the grasping apparatus (and frame 102) to reconfigure between the first configuration and second configuration.

The linking member 124 may be a wire or cable that extends around the reconfigurable member 122. The linking member 124 is pulled when the linking member 124 is actuated. The length of the linking member 124 is shortened i.e. the length is of the linking member 124 is reduced when it is actuated. Shortening of the linking member 124 causes the reconfigurable member 122 to change shape. The frame 122 comprises a combination of rigid and resilient (i.e. compliant) elements provides structural integrity while still allowing reconfiguration of the frame 122.

In one alternative configuration the linking member 124 may be formed from a substantially rigid wire or cable e.g. a metal wire or cable and the linking member 124 may provide some structural integrity to the frame and make the frame robust to hold shape during flight.

The UAV 100 comprises an actuator 105. The actuator 105 may form part of the grasping apparatus 120. The linking member 124 is operably coupled to the actuator 105. The actuator 105 causes actuation of the linking member 124 to vary the length of the linking member 124. Preferably the linking member 124 is shortened by the actuator 105, in order to reconfigure the shape of the grasping apparatus 120 (and frame 102) from a first configuration to a second configuration. The actuator 105 applies a tensile force to shorten the linking member 124 to cause reconfiguration of the grasping apparatus 120 (and frame 102). Reducing the length of the linking member 124, causes the reconfigurable member 122 to reduce in perimeter due to the linking member 124 pulling on the reconfigurable member.

The actuator 105 may also lengthen the linking member 124 by reducing the tensile force to cause the grasping apparatus to open i.e. move from the second configuration to a first configuration (i.e. from a grasping configuration to a release configuration). The actuator 105 may be of a number of suitable actuator such as for example a DC motor, brushless motor, pneumatic actuator or other suitable actuator. Preferably the actuator 105 may also include a pulley or other suitable structure to wrap the linking member 124 about. The reconfiguration of the frame 102 (and grasping apparatus 120) changes the dimensions of the drone without affecting the flight dynamics or the relative positions of the propulsion units 110-113.

The frame 102 comprises one or more compliant pads 106. As shown in FIGS. 1 and 2, the compliant pads 106 are disposed on the inner surface (i.e. inner side) of the reconfigurable member 122. The compliant pads 106 are preferably formed from a soft or compliant material such as for example foam or rubber (e.g., urethane or silicone rubber). The compliant pads 106 are capable of compression to protect the package 101 when grasped by the grasping apparatus 102. In this embodiment, the pads 106 are spaced in use around the inner perimeter of the frame 102, and are preferably equidistant from one another. However, alternative configurations, the pads 106 may be unevenly spaced or many suitable number of pads 106 may be used. The pads 106 are configured to contact each other to form a substantially continuous ring when the grasping apparatus 120 (i.e. the reconfigurable member 122) is positioned in a grasping configuration.

The frame 102 is in it most compressed form and the pads 106 form a substantially continuous pad structure 106 that surrounds the object 101, protecting the parcel as well as grasping it in order to allow the parcel 101 to be lifted and transported to a delivery destination. The compliant pads 106 and the material used to form the compliant pads preferably also increases the friction between the parcel 101 surface and the pad surface, in order to grasp the object 101 stably. Reconfiguration of the frame 102 (and grasping apparatus) causes the frame to contact the object 101 to grasp the object. The frame 102 may be formed out of a resilient member such that the frame 102 can substantially conform to the shape of the object 101.

The frame 102 (and grasping apparatus 120) deforms (i.e. reconfigures) in multiple directions. The frame 102 is capable of at least two degrees of freedom as it reconfigures in shape. The frame 102 is under actuated and hence requires only a single actuator to control the length of the linking member 124. The UAV being under actuated reduces the weight and number of parts required for the grasping apparatus 120 and the frame 102 to allow grasping of objects.

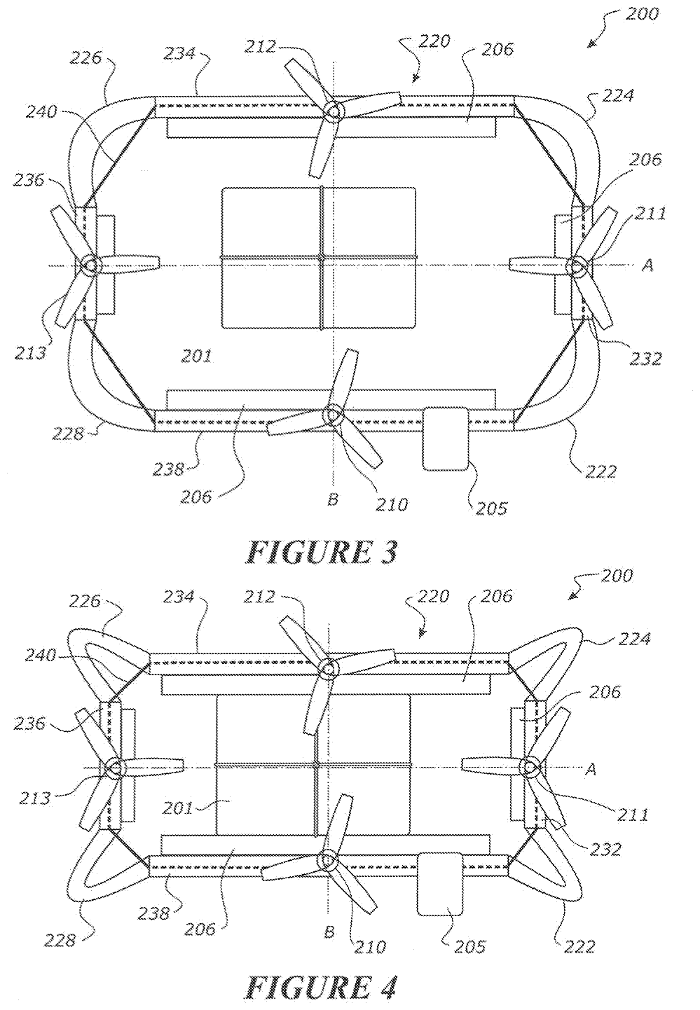

A second embodiment of an unmanned aerial vehicle of the present invention is shown in FIGS. 3 and 4. The drone 200 is in an open configuration (i.e. ungrasping configuration) in FIG. 3 and a closed configuration (i.e. a grasping configuration) in FIG. 4.

In FIG. 3, the drone 200 is in an open configuration and being positioned about a parcel 201. The UAV 200 comprises a frame 202, a plurality of propulsion units and a grasping apparatus 220. The propulsion units 210-213 are disposed on the frame 202. They move with the frame. As shown in FIGS. 3 and 4, the drone 200 comprises four propulsion units 210-213. The four propulsion units 210-213 are preferably evenly spaced around the frame 202. The frame 202 is a polygon shaped frame. As shown in FIGS. 3 and 4, the frame 202 is substantially rectangular in shape. Many polygon shaped frame can be used e.g. rectangular shaped, pentagon shaped, hexagon shaped or other polygon shapes. The polygon frame preferably is shaped to have at least one axis of symmetry i.e. the frame is symmetrical about at least one axis to provide stability in flight. A propulsion unit is positioned at each corner of the frame to provide stability during flight of the drone 200. The propulsion units 210-213 may be of many suitable propulsion units e.g. a propeller or rotor. The propulsion units 210-213 may be similar to the propulsion units 110-113.

The propulsion units 210-213 are preferably equally spaced from each other to balance the UAV during flight such that the UAV (i.e. drone) is stable once it has grasped the payload and such that the UAV is stable in flight. Many number of propulsion units may be used as is appropriate for the size and payload required of the particular drone 200.

The grasping apparatus 220 forms part of the frame 202. Preferably the grasping apparatus 220 defines the frame 202 such that the frame 202 functions to grasp an object e.g. a payload 201. The grasping apparatus 220 (and frame 202) alters shape such that the perimeter of the grasping apparatus 220 (and frame 202) changes as the grasping apparatus 220 is reconfigured in shape from a first configuration (ungrasping configuration) to a second configuration (grasping configuration). FIG. 4 shows the grasping apparatus 220 (and frame 202) in a grasping configuration. As can be seen from FIG. 3 and FIG. 4, the perimeter of the frame 202 reduces as the frame 202 (and grasping apparatus 220) is reconfigured i.e. altered in shape. The grasping apparatus 220 defines the frame 202 in this embodiment i.e. the grasping apparatus 220 forms the frame 202 of the UAV 200.

The grasping apparatus 220 comprises one or more reconfigurable members and one or more rigid members. The one or more reconfigurable members are configured to alter shape as the grasping apparatus is reconfigured from a first configuration (ungrasping configuration) to a second configuration (a grasping configuration). The reconfigurable members may comprise a combination of compressible structures (e.g., an elastomer spring-like structure, a spring loaded linear joint etc.). The rigid members are formed from a light weight, durable, rigid material such as for example a rigid plastics material, carbon fibre or a light weight metal e.g. aluminium or titanium.

As shown in FIGS. 3 and 4, the illustrated grasping apparatus comprises four reconfigurable members 222, 224, 226, 228 and four rigid members 232, 234, 236, 238. The reconfigurable members 222-228 are connected with the rigid members 232-238. As shown in FIGS. 3 and 4, at least one reconfigurable member is interconnected between two rigid members. The reconfigurable members 222-228 are configured to change shape when the grasping apparatus 220 (and frame) changes shape from a first configuration to a second configuration and vice versa. FIG. 3 shows the grasping apparatus 220 (and frame 202) in a first configuration that corresponds to a release/ungrasping configuration. FIG. 4 shows the grasping apparatus 220 (and frame 202) in a second configuration that corresponds to a grasping configuration. The perimeter of the grasping apparatus 220 (and frame 202) reduces as the grasping apparatus reconfigures to the grasping configuration. The reconfigurable members 222-228 deform i.e. alter shape as the grasping apparatus 220 moves to the grasping configuration. The reconfigurable members 222-228 are preferably resiliently deformable members and therefore can change shape as the grasping apparatus 220 moves to the first configuration (i.e. ungrasping), shown in FIG. 3.

The grasping apparatus 220 comprises a linking member 240. The linking member 240 extends around the perimeter of the grasping apparatus 220 (and frame 202). The linking member 240 extends about the reconfigurable members and the rigid members. The reconfigurable members 222-228 and rigid members 232-238 may include a hollow passage. The linking member may pass through at least one or more of the reconfigurable members 222-228 or rigid members 232-238 or both. In the illustrated embodiment of FIGS. 3 and 4, the linking members 240 passes through hollow rigid members 232-238 and passes adjacent the reconfigurable members 222-228.

The linking member 240 may be wire, fibre, cable or belt. Other types of linking members can also be used (e.g., linear motion systems, linkages etc.). The linking member 240 interconnects the rigid members 232-238. The rigid members 232-238 of the second embodiment, shown in FIGS. 3 and 4, are spaced apart from each other and coupled to a reconfigurable member. The linking member 240 extends through the rigid members 232-238 and interconnects them to each other. The rigid members 232-238 include a hollow passage. The linking member 240 is passed through the hollow passage in the rigid members. In some configurations the reconfigurable members may also comprise a hollow passage and the linking member 240 may be passed through the passage in the reconfigurable members. The rigid members 232-238 support propulsion units 203 since they are robust and do not deform in use. The UAV 200 may comprise additional or separate structures to support the propulsion units. These additional structures can connected to the frame by suitable process e.g. welding or adhering or using suitable fasteners e.g. screws or rivets or clamps or clips.

The UAV 200 comprises an actuator 205. The actuator 205 may be located on any one of the rigid members. The linking member 240 is operably connected to the actuator 205. The actuator 205 is configured to apply a force to the linking member 240 to adjust the length of the linking member in order to reconfigure the shape of the grasping apparatus 220 (and frame 202). In the illustrated embodiment of FIGS. 3 and 4, the actuator applies a tensile force to the linking member 240, to shorten the linking member 240. The actuator 205 applies a tensile force to pull the linking member 240, and the linking member 240 is wound or wrapped about an appropriate structure associated with the actuator e.g. a pulley (not shown).

The pulling of the linking member 240, causes the grasping apparatus 220 (and frame 202) to reconfigure in shape. The reconfigurable members 222-228 bend or deform resiliently as the linking member 240 length is reduced, as shown in FIG. 4. The reconfigurable members 222-228 may substantially fold in half as the rigid members are moved toward each other due to the tension of the linking member 240. The reconfigurable members 222-228 can revert back to a rest position, as shown in FIG. 3, when the length of the linking member 240 is increased i.e. the tension is reduced from the actuator 205.

The perimeter of the grasping apparatus 220 (and frame 202) is altered during reconfiguration. The perimeter of the grasping apparatus 220 (and frame 202) is reduced as seen in FIG. 4. Expressed another way the inner area is reduced as the grasping apparatus 220 and frame 202, is reconfigured in shape from a first configuration (ungrasping configuration) to a second configuration (as grasping configuration). Reduction of the perimeter and/or the inner area of the grasping apparatus 220 (and frame 202) causes the grasping apparatus 220 to contact the object 201 (i.e. payload). Reconfiguration of the shape of the grasping apparatus 220 allows the grasping apparatus 220 (and frame 202) to grasp the object 201 by contacting the object. The frame 202 contacts the object 201 at a plurality of locations in order to improve the grasp of the object. The frame 202 creates at least two points of contact when the frame 202 (and grasping apparatus 220) is reconfigured into a grasping configuration i.e. second configuration.

The UAV 200 comprises one actuator 205 since it is operated in an underactuated manner. The grasping apparatus 220 (and frame 202) is capable of two degrees of freedom. The rigid members 234, 238 move toward each other along a longitudinal axis A of the frame 202. The rigid members 232, 236 move toward each other along a transverse axis B of the frame 202. The grasping apparatus 220 (and frame 202) move along two axes as the grasping apparatus 220 (and frame 202) is reconfigured in shape from a first configuration to a second configuration. The grasping apparatus 220 (and frame 202) is under-actuated and hence includes a single actuator 205 in order to control the length of the linking member 240.

The reconfiguration of the frame 202 (and grasping apparatus 220) changes the dimensions of the drone without affecting the flight dynamics or the relative positions of the propulsion units 210-213. The frame 202 (and grasping apparatus 220) also remains substantially planar and the reconfigurable members deform in a manner to prevent torsion of the frame 202 (and grasping apparatus 220). The frame 202 (and grasping apparatus 220) maintains a substantially symmetrical shape in order to reduce the affects on flight dynamics of the UAV 200. The symmetrical shape in of the frame 202 in the first configuration and second configuration reduce impacts on flight of the UAV 200.

The reconfigurable members 222-228 comprises a combination of rigid elements and resilient i.e. compliant elements. The rigid elements function as linkages between each pair of compliant elements. The combination of rigid elements and compliant elements limit deformation along a single plane in order to maintain stability during flight. The deformation may be in two planes, but the reconfigurable members are arranged and connected with the linking member such that there is symmetrical deformation in order for the UAV to remain stable in flight. In one example the reconfigurable members 222-228 may have a similar construction to the reconfigurable member 102 as described above.

The reconfigurable grasping apparatus 220 (and frame 202) comprises a plurality of compliant pads 206 disposed on an inner surface of the grasping apparatus 220. The pads 206 may be formed of a compressible or resiliently compressible material such as foam, urethane rubber or silicone rubber. The compliant pads 206 may be similar in material to the pads 106 described earlier. The compliant pads 206 facilitate the execution of stable, robust grasps without crushing the object. In this embodiment, the pads 206 are continuous and are positioned symmetrically at the inner sides of the rigid members of the frame 202. However, in other configurations, the pads 206 may be unevenly spaced or less or more pads can be used.

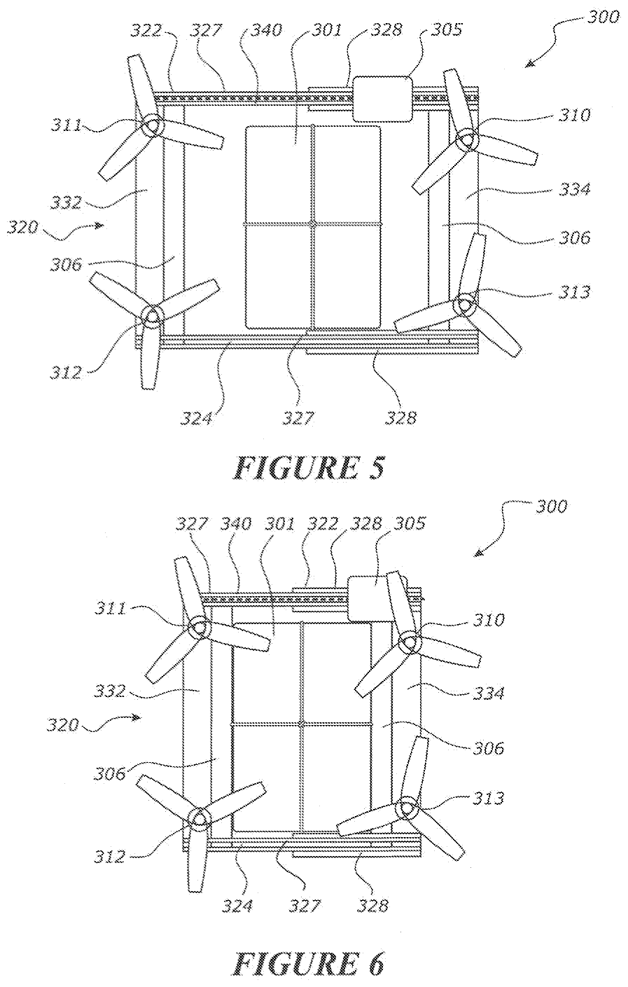

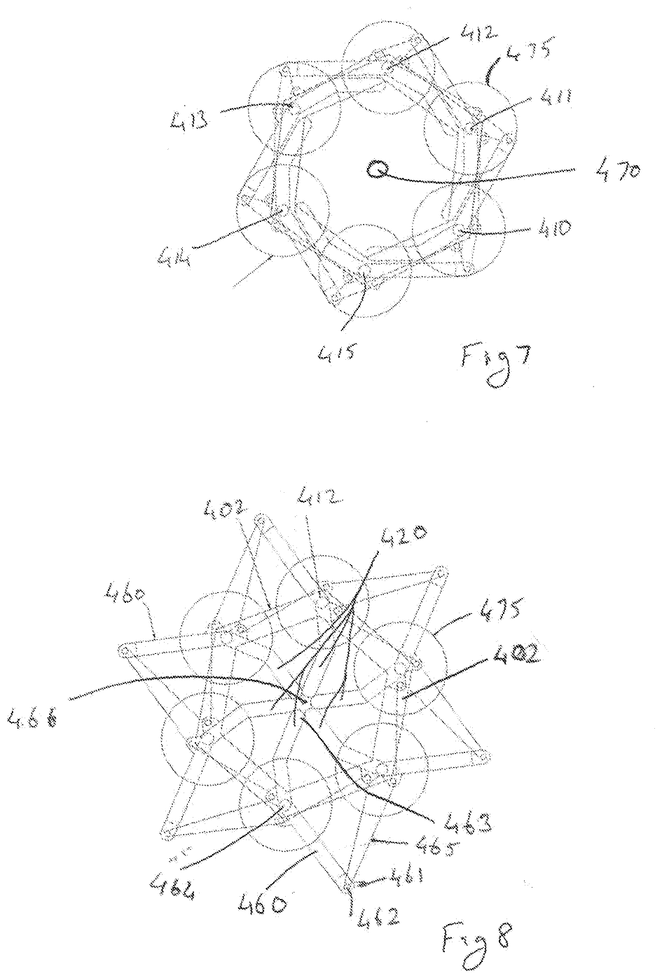

A third embodiment of the reconfigurable grasping drone of the present invention is shown in FIGS. 5 and 6. The UAV 300 (i.e. drone) is in a first configuration in FIG. 5 corresponding to an ungrasping configuration, and a second configuration in FIG. 6 corresponding to a grasping configuration.

Referring to FIG. 5, the UAV 300 is in an open configuration and ready to grasp parcel 301. The UAV 300 comprises a frame 302, a plurality of propulsion units 310, 311, 312, 313 and a grasping apparatus 320. The propulsion units 310-313 are disposed on the frame 302. The propulsion units 310-313 may be anchored to the frame 302 in suitable manner. The propulsion units 310-313 may be rotors or propellers or other suitable propulsion units that are configured to provide thrust and lift to the UAV 300 to facilitate flight and movement through the air for the UAV. As shown in FIGS. 5 and 6, the propulsion units 310-313 are propellers with associated motors. The propellers comprise three blades but more blades may be used depending on the amount of propulsion and lift required. The propulsion units 310-313 are preferably evenly spaced about the frame 302 in order to maintain stability in flight and to allow for easy control of the UAV in flight.

The grasping apparatus 320 may form part of the frame 302. The grasping apparatus 320 defines the frame 302 in this embodiment, such that the frame 302 acts as the grasping apparatus 320 to grasp or release an object e.g. a payload or parcel. The grasping apparatus 320 (and the frame 302) is configured to alter shape i.e. reconfigure in shape between a first configuration and a second configuration to grasp an object 301. The first configuration corresponds to a release or ungrasping configuration and the second configuration corresponds to a grasping configuration. FIG. 5 shows the grasping apparatus 320 (frame 302) in a first configuration and FIG. 6 shows the grasping apparatus 320 (frame 302) in a second configuration. As can be seen in FIGS. 5 and 6, the perimeter of the grasping apparatus 320 (and frame 302) reduce as the grasping apparatus 320 (and frame 302) is reconfigured in shape from a first configuration to a second configuration. The internal area i.e. area defined by the inner surfaces of the grasping apparatus 320 (and frame 302) is also reduced such that one or more inner surfaces of the grasping apparatus 320 (and frame 302) contact and grasp the object 301.

The grasping apparatus 320 comprises one or more reconfigurable members. The reconfigurable members are configured to alter shape i.e. change shape as the grasping apparatus 320 (and the frame 302) is configured from a first configuration (release configuration) to a second configuration (grasping configuration). In the illustrated embodiment the grasping apparatus 320 (and frame 302) comprise a pair of reconfigurable members 322, 324 and a pair of rigid members 330, 332. The grasping apparatus 320 can be of many suitable shapes and may comprise a plurality of reconfigurable members and a plurality of rigid members.

The reconfigurable members 322, 324 are changeable in length. As shown in FIGS. 5 and 6, the reconfigurable members comprise a telescoping arrangement 326. Each reconfigurable member is configured to telescope in length, i.e. increase or decrease in length. As shown in the illustrated embodiment each reconfigurable member 322, 324 comprises a telescoping arrangement 326. Each reconfigurable member 322, 324 comprises a first rod 327 and a hollow second rod 328, wherein the first rod 327 is nested into the second rod 328 and can extend into or out of the second rod. Other telescoping arrangements may also be used to create the reconfigurable member. Alternatively the reconfigurable members may comprise spring loaded linear joints instead of the telescoping arrangement. As a further alternative the telescoping arrangement i.e. telescoping joints may be spring loaded so as to bias the reconfigurable member to ungrasping configuration. In a further alternative the reconfigurable members may comprise linear motion systems or other extendable linkages that allow a portion of the member to move linearly.

The rigid members 332, 334 are configured to maintain their dimensions and provide rigidity and structure to the grasping arrangement 320 (and frame 302). As shown in the illustrated embodiment a reconfigurable member is extends between a pair of rigid members 332, 334, and is connected between two rigid members 332, 334. The reconfigurable members are connected to the rigid members by a suitable stiff connection or a stiff fastener that prevents torsion or pivoting of the reconfigurable members relative to the rigid members. The connection may be a weld or may include fastener such as bolts or screws or rivets or many other suitable connection or fastener. In some configurations elastic connectors or elastic connections that geometrically trap the two members together may be used.

The grasping apparatus 320 (and frame 302) maintains a substantially planar structure to avoid affecting the stability of the UAV 300 in flight. The rigid members 332, 334 support the rotors 310-313. As shown in FIGS. 5 and 6, each rigid member supports two rotors 310-313 and the rotors are mounted on the rigid members using a suitable mounting structure.

The grasping apparatus 320 comprises a linking member 340. The linking member extends through at least one reconfigurable member. As shown in FIGS. 5 and 6, the linking member extends along the length of one reconfigurable member 322. The linking member 340 may be a wire, cable or belt that is of a fixed length and connected to each end of the reconfigurable member 322. Alternatively the connecting member may extend the length of the reconfigurable member and connect to each rigid member 332, 334.

The grasping apparatus 320 comprises an actuator 305. The linking member 340 is operably coupled to the actuator 305. The actuator 305 is configured to control or alter the length of the linking member 340 in order to cause reconfiguration of the grasping apparatus 320 (and frame 302). The actuator may be many suitable actuators such as for example a linear motor, a DC motor, a brushless motor etc. The actuator 305 may be similar in construction to the actuator 105 or actuator 205. The actuator 305 may comprise a pulley or other suitable structure about which the linking member 340 can be wound. The actuator 305 is configured to wind up the linking member 340 to cause reconfiguration of the reconfigurable members 322, 324. This in turn causes a change in shape of the grasping apparatus 320 (and frame 302).

The actuator is configured to apply a force e.g. a tensile force to reduce the length of the linking member 340 and cause reconfiguration of the grasping apparatus 320 (and frame 302) from a first configuration (i.e. release configuration) to the second configuration (i.e. grasping configuration). The second reconfigurable member 324 may not include a linking member 340 but also can reconfigure due to the pulling force from the linking 340 being pulled and wound about the actuator or pulley. The perimeter of the grasping apparatus 320 (and frame 302) and the inner area is reduced due to the actuation of the linking member 340. Expressed in another way the dimension of the reconfigurable members changes e.g. shortens in order to bring the rigid members closed together, hence reducing the perimeter of the grasping apparatus 320 as the grasping apparatus is reconfigured into a grasping configuration.

The actuator 305 may be mounted on many suitable locations such as for example on a portion of the reconfigurable member. The grasping apparatus 320 (and frame 302) remains substantially planar and symmetrical as it is reconfigured in order to maintain flight dynamics and reduce in-flight instability.

The grasping apparatus 320 comprises a plurality of compliant pads 306 that facilitate robust, secure and stable grasping of an object 301, while reducing damage to the object e.g. crushing the object. The one or more compliant pads are preferably positioned in the inner surface of each of the rigid members 332, 334 of the reconfigurable drone. In this embodiment the pads 306 may be made from a foam like or suitable elastomer material (e.g., urethane or silicone rubber etc.). In this embodiment, the pads 306 are continuous and positioned symmetrically but multiple kind of positioning may be implemented. The pads 306 may be similar to the pads 206 described earlier. Alternatively the grasping apparatus 320 may comprise a plurality of spaced apart compliant pads that may be positioned on the rigid members and/or reconfigurable members.

In an alternative embodiment to the UAV 300, the grasping apparatus 320 may comprise a plurality of telescoping reconfigurable members. The reconfigurable members may be hydraulic or pneumatic pistons. The actuator 305 may be configured to control reconfiguration of the shape of the grasping apparatus controlling the pistons.

In a further alternative embodiment the UAV may comprise a single actuator to control each single reconfigurable member (e.g., a linear actuator). The system may comprise a single controller or a remote control that allows a user to control the actuators to vary the configuration of the grasping apparatus and frame. In yet other constructions the reconfigurable members may comprise compliant dielectric material that can change shape when a current is applied to these materials. In some constructions different combinations of reconfigurable members i.e. different types of reconfigurable members may be used in conjunction with each other to achieve a desired orientation/configuration of the frame/grasping apparatus for grasping.

Many suitable number of propulsion units can be used on the UAV. The number of propulsion units utilised in many UAV are dependent on the size and specifications of the UAV. For example the UAV may include additional propulsion units in order to increase the lifting capacity of the UAV. A UAV incorporating an integrated grasping apparatus that defines a frame of the UAV (or a UAV that may have a grasping apparatus coupled to it), as described above, comprises at least two propulsion units in order to provide stable flight. All the embodiments described herein comprise two or more rotors in order to compensate for center of mass changes due to grasping and lifting a payload.

The number of reconfigurable members and rigid members may be varied depending on the type of grasping shape that is desired. In the embodiments described above the specific construction of the grasping apparatus in particular the orientation of the reconfigurable members and number of actuators can allow complex shapes to be grasped. In some embodiments the reconfigurable members as described herein may comprise a concertina structure that allows movement/reconfiguration of each reconfigurable member.

In some embodiments the grasping apparatus (and frame) may also comprise additional sensors to sense that an object has been grasped. Some examples can include a camera, tactile sensors or limit switches etc. These sensors can provide feedback regarding if the object has been grasped, and the amount of further actuation required to improve the grasp. The sensors may also provide feedback to control the amount of actuation to achieve a good quality grasp of an object without crushing the object.

The grasping apparatus being integral to the frame and defining the frame is advantageous because it reduces the number of parts required for construction of the UAV. The frame functioning as the grasping apparatus also reduces the weight of the UAV since there is no need for a separate grasping structure that is coupled to the frame. The UAV can grasp objects mid-flight with minimal disruption or change to the flight dynamics because the frame reconfigures while maintaining symmetry. The frame being reconfigurable also provides a simpler grasping solution as compared to complex grasping hands etc.

The frame acting as a grasping apparatus also is advantageous because it can help the UAV to perch. The frame acting as a grasping apparatus may function as a perching apparatus to perch on various objects and objects or irregular shape. For example the frame being reconfigured into a grasping configuration can allow the UAV to grasp a pole to allow the UAV to perch on the pole. Similarly the frame being reconfigured to a grasping configuration can allow the UAV to grasp many objects upon which the UAV is required to perch onto. The frame acting as a grasping apparatus allows the UAV to perch on a wider variety of objects and thereby improves usability of the UAV.

In a further aspect the present invention may relate to a grasping apparatus that can be fitted to or is part of a UAV. The grasping apparatus may be a reconfigurable grasping structure that changes shape in order to grasp an object e.g. a parcel. The grasping apparatus for grasping an object comprises a body, the body comprising one or more reconfigurable members that are configured to alter in shape as the grasping apparatus is reconfigured between a first configuration and a second configuration, wherein the second configuration corresponds to a grasping configuration in which the grasping apparatus grasps the object and the first configuration corresponds to a release (i.e. ungrasping) configuration. The grasping apparatus may have a construction similar to the grasping apparatus 120 or 220 or 320 as described herein without the propulsion units. The grasping apparatus may include a coupler that allows the grasping apparatus to couple to a vehicle e.g. an unmanned/manned aerial or ground vehicle. In this embodiment the grasping apparatus may be separate to the frame of the unmanned/manned aerial or ground vehicle and can be removably coupled to a vehicle e.g. an unmanned aerial vehicle. The grasping apparatus as described could be many sized and the size could be based on the type of objects to be held and the size of the vehicle. The grasping apparatus can be appropriately sized and is sufficiently large for its particular grasping requirement. In this embodiment the grasping apparatus may be separate to the frame of the unmanned aerial or ground vehicle and can be removably coupled to a vehicle e.g. an unmanned aerial vehicle.

The separate grasping apparatus may function the same the grasping apparatuses described earlier in this specification, but may be a separate component that can be coupled to the vehicle.

With reference to FIGS. 7-9 there is shown yet a different configuration of UAV with grasping apparatus 420 that behaves like a mechanical iris. The grasping apparatus 420 comprises of a plurality of reconfigurable members such as arms 460. These reconfigurable members are each pivotally connected to the frame 402. They preferably rotate about respective pivot axes 464 that are each parallel each other and preferably parallel the axis of rotation of the propellers of propulsion units 410-415 of the UAV. The axis of rotation of the propellers is preferably concentric a respective pivot axis 464 of an arm 460 as seen in FIG. 9. The propeller's rotational circle 474 is shown with reference to one propulsion unit 411.

The arms are able to rotate about their respective pivot axes independently yet in an interconnected manner that will hereinafter be described.

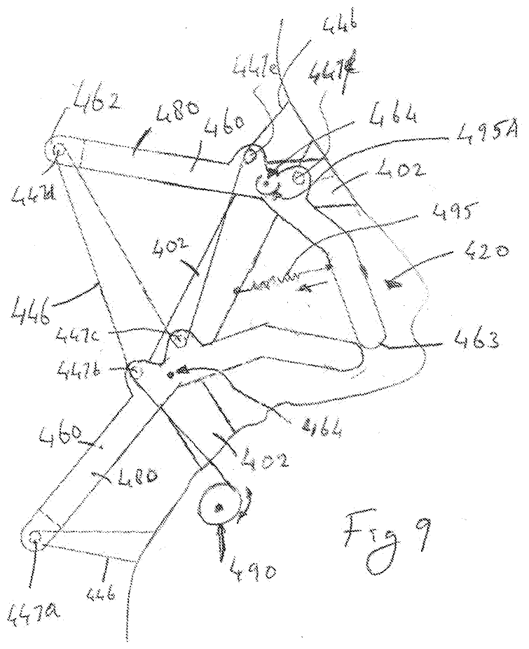

The grasping mechanism 420 may comprise of a plurality of reconfigurable members such as 6 arms 460 as shown but any number of arms can be used (6 arms provide a good grasping performance and a lightweight structure). The number of arms may determine the shape of the frame. For six arms the frame may be hexagonal while for 8 arms the shape of the frame may be octagonal. The arms present arm tips 463 that are each able to contact an object 470 to be grasped. The arm tips are presented at the end of the arms at where the arms converge to each other when moving towards or have moved to their grasping condition as seen in FIG. 8. The tips are preferably inboard of the frame. Each arm extends from its pivot axis to the arm tip. Each arm may also extend in another direction from the pivot axis to present a lever portion 480 of the arm. The lever portion has a distal end 462 that is preferably outboard of the frame. A force can be applied to the lever portion 480 so as to cause the arm to move. This in turn causes the tip of each arm to move. The movement causes each arm to rotate about its pivot axis 464. The tips of the arms can each contact the object 470 to be grasped. The tips of the arms can be moved between a grasping condition as for example seen in FIG. 8 and a non-grasping condition as for example seen in FIG. 7. In the no-grasping condition the arms are drawn closer to the frame as seen in FIG. 7. The tips may include a rubber or grippy material to help grasp the object. The grasping ends of the arms may be covered by a layer of compliant material to maximize friction with the gripped object. The grasping and holding relies on frictional engagement between the arms and the object as otherwise the object may fall out from between the arms. This requires a sufficient normal force to be applied to the object by the arms in a direction parallel the plane in which the arms move when rotating about their respective axes 464.

In the preferred form the arms are biased to their grasping condition. A biasing means 495 for each arm may be provided to achieve this. The biasing means many be a coil spring acting between the arm and the frame. It may be a leaf spring acting between the arm and the frame or it may be a torsional spring acting between the arm and the frame. Several elastic elements can be considered such as rubber bands, flexure joints or linear springs. In the preferred form it's a torsional spring 495A located about the pivot axis 464 of each arm.

Alternatively actuators may be used such as servo actuators or screw thread actuators to control the position of the arms about their rotational axis and relative to the frame.

The propulsion units 410-415 remain fixed relative the frame. They hence remain in the same spaced relationship relative to each other despite the configuration of the grasping apparatus 420. The propulsion units are preferably equispaced relative each other.

The frame 430 preferably consists of two plates (upper and lower plate, hexagonal in this case) with the arms supported between the two plates.

The arms 460 are preferably able to move semi-independently of each other, resulting in a differential closing action which grasps objects such as object 470 in a way that all arms contribute in grasping the object. In the preferred form the arms are biased to their grasping condition by the biasing means 495 and are able to be moved to a release condition by a flexible elongate member 446 such as a cable or wire or rope of the like (wherein after “wire”). The wire 446 spools around pulleys 447a-f and so forth as seen in FIG. 9. One end of the wire may be anchored to the frame and one of the wire may anchored to a spool 490 at where and by which the effective length of the wire can be changed. The spool is preferably secured to the frame. A winding of the spool in the clockwise direction as seen in FIG. 9 will result in wire reducing in effective length and the geometry of the arms and positioning of the pulleys results in the arms moving from the grasping condition to the release condition. The wire will apply an lever force at the pulleys 447a,d at the ends of the lever portions 480 of each arm to cause the arms to move. This will for example move the arms from the condition shown in FIG. 8 to the condition shown in FIG. 7.

The passive movement of the arms to the grasping condition will help ensure a conforming to the object geometry and maximizing the contact area with the object/package. The wire routing arrangement shown allows for passive closing of the mechanism—as the wire is drawn onto the spool, the outer ends of the of arms are pulled inwards towards the frame.

The spool may be driven by an electric motor. Preferably it is a single stepper motor, which was deemed appropriate because of the large amount of holding torque.

The motor and spool geometry will need to be such as to overcome the biasing forces acting on the arms by the respective biasing means to ensure the arms can move to their release condition. By using a wire that extends around each of the of the distal end pulleys 447a,d etc all of the arms are able to be caused to move by the one wire. The movement is actuated by winding the wire around the spool. As the wire is wound, it exerts forces on the individual arms to make them move to the release condition. Energy is stored in biasing means as a result. When the spool unwinds the wire, the energy stored in the biasing means exerts forces on the arms that make them move to a grasping condition. This mechanism acts as a differential. If an arm is immobilized while it is moving between the grasping and release conditions the wire can keep on winding on/off the spool until all arms are immobilized. This particular behaviour allows the grasping apparatus to conform to various object geometries and shapes. The spool may instead be some other form of actuator to cause the effective length of the wire to be varied. A ram or pulley mechanism or servo controlled lever arm may for example be used instead.

The preferred configuration of the spool and wire results in a power requirement to move the arms from their grasping condition to a release condition. This means that when grasping it is the force of the biasing means that holds the object and there are no power requirements for the spool. Only when a release is desired will there be a need to power the spool. This can help save energy onboard the UAV.

The motor of the spool may include a feedback to determine when the collective limits of movement of the arms are reached. This may then trigger the motor to stop winding on/off the wire to/from the spool.

In alternative forms the biasing means may act between the frame and the lever portion of the arms. In alternative forms the cable may be routed in a manner to act on the arms between their pivots and the gripping tips. In some embodiments its envisaged that the arms do not have a lever portion and control of the arm position is exercised on the arms between their pivots and the gripping tips.

Additionally, although the proposed mechanism is designed to execute passive closing and active opening, an active closing—passive opening design could also be used for the reconfigurable drone.

Throughout the description like reference numerals will be used to refer to like features in different embodiments.

Any discussion of the prior art throughout the specification should in no way be considered as an admission that such prior art is widely known or forms part of common general knowledge in the field.

Preferred embodiments of the invention have been described by way of example only and modifications may be made thereto without departing from the scope of the invention.

1.-3. (canceled)

4. An unmanned aerial vehicle according to claim 32 wherein a least a portion of the frame is configured to change shape as the grasping apparatus is reconfigured between the rest configuration and the deformed configuration.

5. An unmanned aerial vehicle according to claim 31 wherein the grasping apparatus comprises one or more reconfigurable members that are configured to alter in shape to reconfigure the grasping apparatus between a first configuration and a second configuration.

6.-8. (canceled)

9. An unmanned aerial vehicle according to claim 32 wherein the grasping apparatus comprises one or more rigid members and wherein the one or more deformable members are coupled to the one or more rigid members.

10. An unmanned aerial vehicle according to claim 9 wherein the grasping apparatus comprises a polygon shape, the polygon shape being defined by a plurality of the rigid members and a plurality of the deformable members.

11. An unmanned aerial vehicle according to claim 9 wherein each deformable member is interconnected between two rigid members, the deformable member separating the two rigid members from each other and altering the distance between them.

12.-13. (canceled)

14. An unmanned aerial vehicle according to claim 5 wherein the grasping apparatus comprises a linking member, the linking member being coupled to at least the one or more reconfigurable members such that actuation of the linking member causing the one or more reconfigurable members to reconfigure in shape thereby causing the grasping apparatus or the frame to reconfigure between the first configuration and second configuration and/or any position between the first configuration and second configuration.

15.-16. (canceled)

17. An unmanned aerial vehicle according to claim 14 comprising an actuator, the linking member being coupled to the actuator and the actuator configured to vary the length of the linking member in order to cause reconfiguration of the one or more reconfigurable members based on the length of the linking member.

18. An unmanned aerial vehicle according to claim 17 wherein the actuator is configured to vary the length of the linking member by applying a tensile force to the linking member.

19. An unmanned aerial vehicle according to claim 17 wherein the actuator is configured to reduce the length of the linking member in order to reduce the perimeter of the grasping apparatus such that the grasping apparatus is reconfigured into the second configuration for grasping a payload.

20.-28. (canceled)

29. An unmanned aerial vehicle according to claim 32 wherein the perimeter of the frame is altered as the one or more deformable members is moved in order to grasp or release a payload.

30. (canceled)

31. An unmanned aerial vehicle for carrying a payload comprising:
a frame
a plurality of propulsion devices disposed on the frame,
the frame comprising one or more members defining a grasping apparatus, the one or more members being moveable to alter the perimeter of the frame to thereby grasp and release the payload.

32. An unmanned aerial vehicle (UAV) comprising:
a chassis,
a plurality of propulsion units disposed on the chassis and configured to provide propulsion to the UAV,
a grasping apparatus associated with the chassis, the grasping apparatus comprises one or more deformable members, the one or more deformable members defining the grasping apparatus and wherein the one or more deformable members are configured to deform between a rest configuration and a deformed configuration in order to grasp a payload.

33. An unmanned aerial vehicle (UAV) comprising:
a frame,
a plurality of propulsion units disposed on the frame and configured to provide propulsion to the unmanned aerial vehicle,
the frame comprising a plurality of deformable members and a plurality of rigid members, at least one deformable member being interconnected to at least one rigid member,
an actuator operatively coupled to the plurality of deformable members, the actuator configured to alter the shape of the plurality of deformable members such that the shape or perimeter of the frame is altered in order to grasp a payload.

34. An unmanned aerial vehicle according to claim 33, wherein the grasping apparatus comprises:
a body,
the body comprising one or more reconfigurable members that are configured to alter in shape as the grasping apparatus is reconfigured between a first configuration and a second configuration, wherein the second configuration corresponds to a grasping configuration in which the grasping apparatus grasps the object and the first configuration corresponds to a release (i.e. ungrasping) configuration.

35.-37. (canceled)

38. An unmanned aerial vehicle according to claim 34 wherein the grasping apparatus comprises one or more rigid members and wherein the one or more reconfigurable members are coupled to the one or more rigid members.

39. (canceled)

40.-52. (canceled)

53. An unmanned aerial vehicle according to claim 33, wherein the frame comprises:
a body to peripherally locate about the payload, wherein the body is reconfigurable between a condition not grasping the payload and a condition where the body is at least in part compliant to the periphery of the payload and applying a normal force to the periphery sufficient to grasp the payload.

54. (canceled)

55. An unmanned aerial vehicle according to claim 5 wherein the plurality of reconfigurable members are arms pivotally engaged to the chassis to each be able to rotate relative the chassis so that distal ends of the arms can displace in a converging and diverging manner relative each other.

56. An unmanned aerial vehicle as claimed in claim 55 wherein the distal ends of the arms are at where the pay load is grasped.

57. (canceled)

58. An unmanned aerial vehicle as claimed in claim 55 wherein the arms are biased towards a rotational position at where the arms are in a grasping condition.

59. (canceled)

60. An unmanned aerial vehicle as claimed in claim 55 wherein the arms are collectively coupled to a flexible elongate member able to contract and expand in effective length and routed with each arm in a manner to cause the arms to collectively pivot about their respective pivot axes as the elongate member contracts and/or expands in effective length.
